(19) United States
(12) Patent Application Publication
(10) Pub. No.: US 2020/0092245 A1
(43) Pub. Date: Mar. 19, 2020

(54) PROVOKING AND MAINTAINING USER ATTENTION FOR URGENT MESSAGES BY ACTIVELY MONITORING USER ACTIVITY AND BIOMETRICS

(71) Applicant: INTERNATIONAL BUSINESS MACHINES CORPORATION, Armonk, NY (US)

(72) Inventors: Trudy L. Hewitt, Cary, NC (US); Jeremy R. Fox, Georgetown, TX (US); Liam S. Harpur, Dublin (IE); Sheelagh Carew, Dundram (IE)

(21) Appl. No.: 16/133,843

(22) Filed: Sep. 18, 2018

(51) Int. Cl. H04L 12/58; H04L 29/08

(52) U.S. Cl. CPC H04L 51/24; H04L 67/22; H04L 51/26

(57) ABSTRACT

A computer-implemented method comprising: monitoring, by the computing device, user behavior and user biometrics of a user, detecting, by the computing device, user device activity of a user device that triggers an attention provoking action; executing, by the computing device, attention provoking instructions based on the detecting the user device activity that triggers the attention provoking action; detecting, by the computing device, that attention level criteria has been satisfied based on the monitoring the user behavior and the user biometrics; and discontinuing, by the computing device, the executing the attention provoking instructions based on the detecting that the attention provoking level has been satisfied.

### BACKGROUND

The present invention generally relates to provoking and maintaining user attention for urgent messages and, more particularly, to provoking and maintaining user attention for urgent messages by actively monitoring user activity and biometrics.

Within software development, developers and designers may envision certain criteria and usage patterns that are considered normal within workflow. For example, when a user is sending an e-mail message, the sender sometimes marks a message with “Important” or “Urgent” or “normal” priority. This marking or flag is intended to have the effect of the recipient treating the message appropriately (e.g., with priority and extra attention).

### SUMMARY

In an aspect of the invention, a computer-implemented method includes: monitoring, by the computing device, user behavior and user biometrics of a user, detecting, by the computing device, user device activity of a user device that triggers an attention provoking action; executing, by the computing device, attention provoking instructions based on the detecting the user device activity that triggers the attention provoking action; detecting, by the computing device, that attention level criteria has been satisfied based on the monitoring the user behavior and the user biometrics; and discontinuing, by the computing device, the executing the attention provoking instructions based on the detecting that the attention provoking level has been satisfied.

In an aspect of the invention, there is a computer program product including a computer readable storage medium having program instructions embodied therewith. The program instructions are executable by a computing device to cause the user device to: monitor user behavior and user biometrics indicating a user's attention level; receive a message that triggers an attention provoking action on the user device; execute attention provoking instructions based on the receiving the message that triggers the attention provoking action; and maintain execution of the attention provoking instructions until the computing device detects, based on the monitoring the user behavior and the user biometrics, that the user's attention level has satisfied a threshold for a threshold period of time.

In an aspect of the invention, a system includes: a processor, a computer readable memory and a computer readable storage medium associated with a user device; program instructions to monitor user behavior and user biometrics, program instructions to provide a message to a user of the user device; program instructions to determine that an urgency level of the message exceeds a threshold; program instructions to execute attention provoking instructions based on the detecting that the urgency level exceeds the threshold; program instructions to detect that attention provoking criteria has been satisfied based on the monitoring the user behavior and the user biometrics; and program instructions to discontinue the executing the attention provoking instructions based on the detecting that the attention provoking criteria has been satisfied. The program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example environment and implementation in accordance with aspects of the present invention.

FIG. 5 shows an example flowchart of a process for initiating an attention provoking action and maintaining the attention provoking action until sufficient time and attention has been given to a message.

### DETAILED DESCRIPTION

The present invention generally relates to provoking and maintaining user attention for urgent notifications and, more particularly, to provoking and maintaining user attention for urgent notifications by actively monitoring user activity and biometrics. When receiving a message (or notification) on a user device (e.g., an e-mail, text message, instant message, emergency alert, application alert, phone call, or the like), the receiving individual may not realize that the message or notification is considered important and should be given additional attention, even if the message or notification includes a marking or other indication of importance or high priority. Accordingly, aspects of the present invention actively monitor a user's behavior, biometrics information (e.g., pulse/heartrate, eye behavior, facial expressions, etc.), and/or other contextual data relating to the user's attention level when the user receives a notification or message that is considered to be important. As used herein, the term “message” may correspond to any type of electronic communication or notification on a user device, such as an e-mail message, a notification, a text message, an application notification, an emergency alert notification, or the like. In other words, the term “message” and “notification” may be used interchangeably.

In embodiments, aspects of the present invention initiate an action on the user device that provokes the user's interest to ensure the user is maintaining sufficient attention when reviewing the notification. Additionally, aspects of the present invention monitor user attention level and initiate provoking actions (e.g., motion sickness type actions to provoke user attention) if the user's attention level is insufficient when reviewing a message. For example, aspects of the present invention monitor the user's eye behavior and/or page scrolling activity to ensure that the user is spending an adequate amount of time reading a message (e.g., that the user is not skipping reading of sentences/paragraphs), and will initiate attention provoking/motion sickness actions to re-focus the user's attention when the user's attention level drops below a satisfactory level. As illustrative non-limiting examples, aspects of the present invention execute attention provoking actions, such as flickering a display of the user device, blinking a certain section of the user device having an important notification/message, outputting an audible alert, adjusting a frame rate of the display, highlighting portions of the display, reduce synchronization of different senses, and/or other actions that provoke and/or re-focus or restore the user's attention. In embodiments, aspects of the present invention continue the attention provoking actions until the user has devoted a sufficient amount of time and attention to the message.

In embodiments, the duration and severity of the attention provoking actions are based on an importance or priority level, or a confidence score indicating the likelihood that a message is considered important. In embodiments, aspects of the present invention delay the execution of the provoking actions if user is not able to endure those actions at a given time or, if the actions could be a danger or greater disruption than warranted by the topic in the message. For example, aspects of the present invention delay the execution of the provoking actions during activities, such as exercising, driving, getting ready to sleep, etc.

In embodiments, notifications are marked as “important” by default or by a sending party of the notification (e.g., a sender of an e-mail may mark an e-mail message as important using an e-mail client). In alternative embodiments, aspects of the present invention determine which notifications are considered important and whether a notification should trigger an action to provoke the user's attention.

In embodiments, aspects of the present invention provide a particular solution to a particular problem through the use of rules. For example, aspects of the present invention provide a solution to the problem of provoking attention for important messages by implementing criteria to provoke user attention based on sensor data and biometrics data indicating the user's attention levels. Aspects of the present invention utilize sensors to gather raw data, and aspects of the present invention process the raw data in a unique manner for provoking, re-focusing, and/or maintaining the user's attention. Aspects of the present invention change an article to a different state by physically altering the output of a user device based on sensor data.

In embodiments, aspects of the present invention are performed locally by components within a user device. Additionally, or alternatively, aspects of the present invention are performed remotely by a remote server in which the remote server generates attention provoking instructions based on user attention levels, and provides the instructions to the user device as a cloud-based service.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

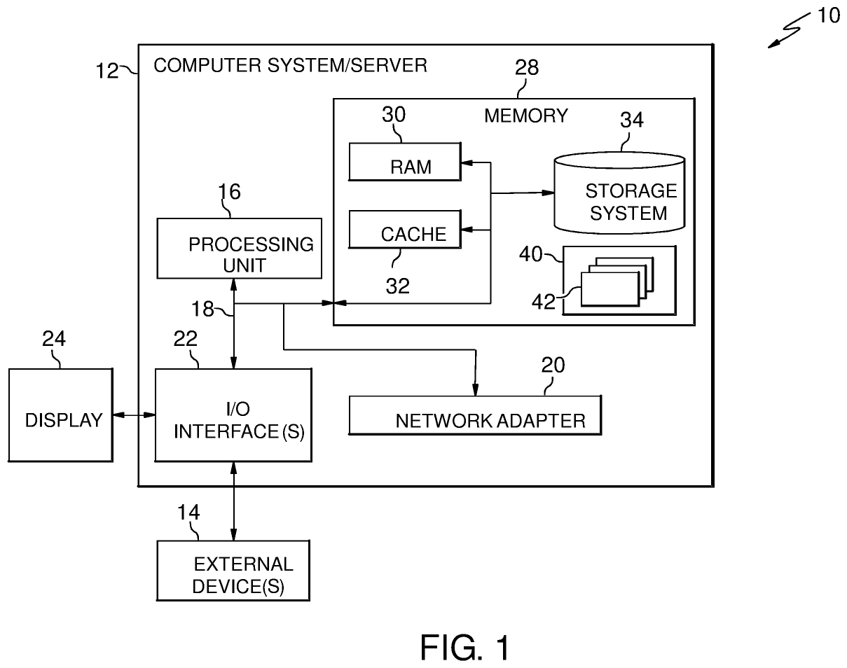

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

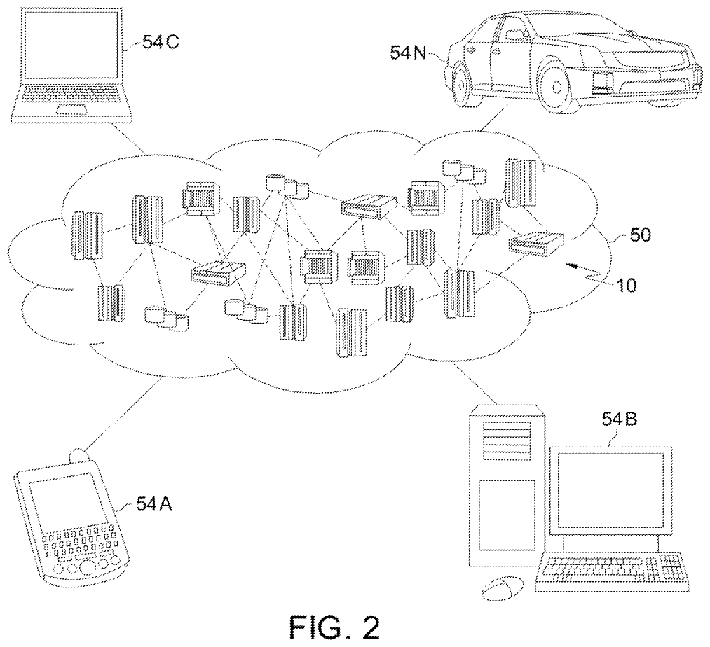

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

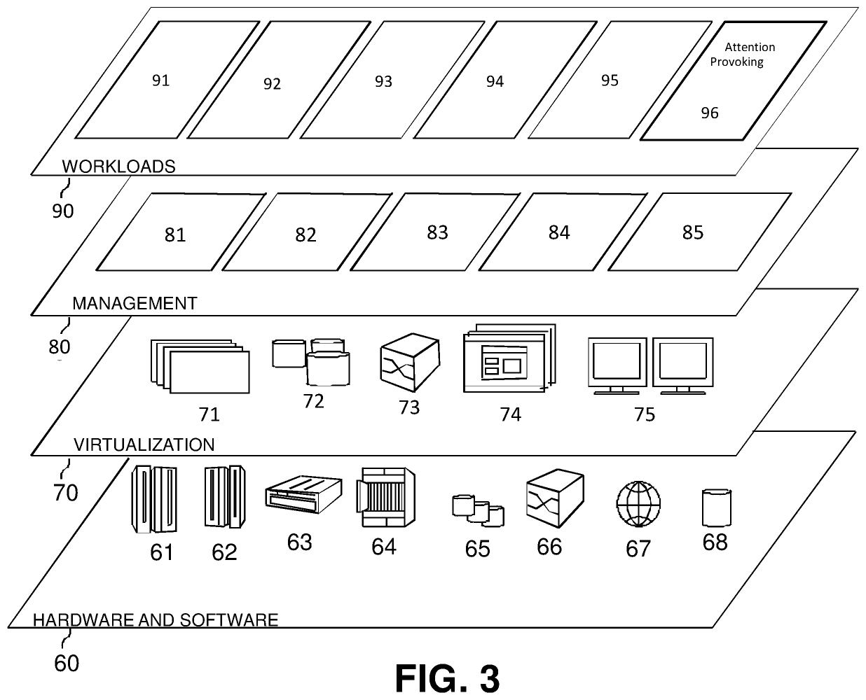

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and attention provoking 96.

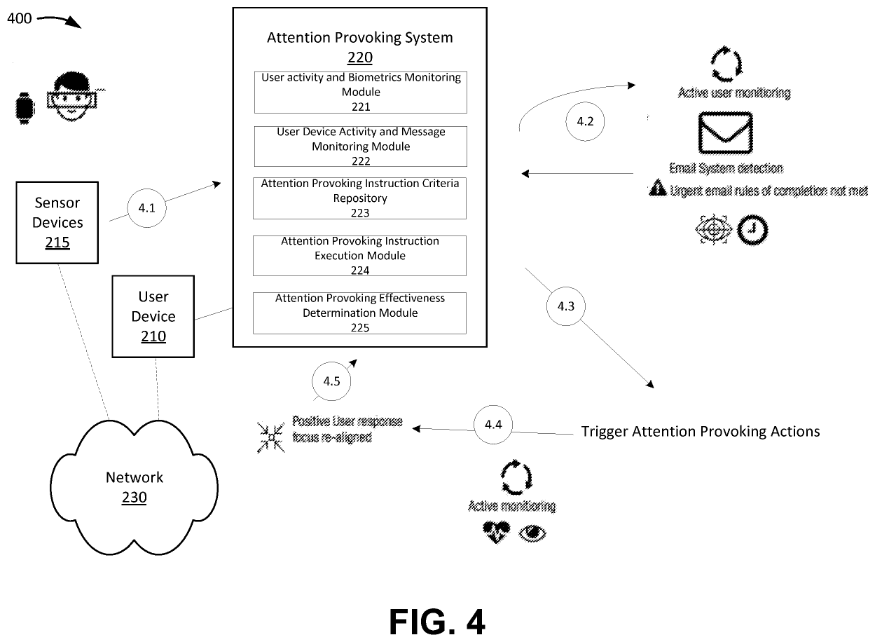

Referring back to FIG. 1, the program/utility 40 may include one or more program modules 42 that generally carry out the functions and/or methodologies of embodiments of the invention as described herein (e.g., such as the functionality provided by attention provoking 96). Specifically, the program modules 42 may monitor user behavior and biometrics, detect user device activity that triggers an attention provoking action for a message, and execute a provoking action until the user has devoted sufficient time and attention for the notification and message. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of an attention provoking system as shown in FIG. 4.

FIG. 4 shows an overview of an example implementation and environment in accordance with aspects of the present invention. As shown in FIG. 4, environment 400 includes a user device 210, sensor devices 215, and a network 230. In embodiments, one or more components in environment 400 may correspond to one or more components in the cloud computing environment of FIG. 2. In embodiments, one or more components in environment 400 may include the components of computer system/server 12 of FIG. 1.

The user device 210 includes a computing device (e.g., such as computer system/server 12 of FIG. 1) capable of communicating via a network, such as the network 230. In example embodiments, the user device 210 corresponds to a mobile communication device (e.g., a smart phone or a personal digital assistant (PDA)), a portable computer device (e.g., a laptop or a tablet computer), a desktop computer, and/or another type of computing device. In some embodiments, the user device 210 includes an attention provoking system 220 which includes one or more components that perform the processes of aspects of the present invention. As shown in FIG. 4, the attention provoking system 220 includes data storage device/program modules (e.g., storage system 34/program module 42 of FIG. 1), such as a user activity biometrics monitoring module 221, a user device activity and messaging monitoring module 222, an attention provoking instructions criteria repository 223, an attention provoking instruction execution module 224, and an attention provoking effectiveness determination module 225.

The sensor devices 215 includes one or more sensors, such as biometrics sensors, audio sensors, video sensors, Internet of Things (IoT) devices, or the like. As described herein, the sensor devices 215 gather sensor data associated with a user, which the attention provoking system 220 processes to determine user activity levels at any given time for determining attention provoking actions to take to provoke, maintain, and/or re-focus the user's attention for reviewing an important notification/message.

The network 230 may include network nodes, such as network nodes 10 of FIG. 2. Additionally, or alternatively, the network 230 may include one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4. Also, in some implementations, one or more of the devices of the environment 400 may perform one or more functions described as being performed by another one or more of the devices of the environment 400. Devices of the environment 400 may interconnect via wired connections, wireless connections, or a combination of wired and wireless connections.

As shown in FIG. 4, the attention provoking system 220 receives and monitors sensor data (step 4.1). For example, the user activity biometrics monitoring module 221 receives sensor data for a user, such as the user's biometrics data and/or other user activity (e.g., the user's speaking activity, movement activity, eye behavior, etc.). At step 4.2, the user device activity and messaging monitoring module 222 actively monitors user behavior with regard to user activity on the user device 210, and notifications and messages received by the user device 210. As an illustrative example, the user device activity and messaging monitoring module 222 receives an e-mail with an embedded urgency flag and/or embedded rules indicating that a certain level of time and attention should be devoted to reading the e-mail. At step 4.3, attention provoking actions are triggered. More specifically, the attention provoking instruction execution module 224 determines a particular set of attention provoking instructions to execute based on criteria stored by the attention provoking instructions criteria repository 223 and the user's current state and attention level from the user's activity and biometrics data monitoring (e.g., data gathered by the user activity biometrics monitoring module 221). In embodiments, the attention provoking instructions criteria repository 223 stores a set of attention provoking instructions criteria that define the particular set of attention provoking instructions to execute based on the user's current behavior/biometrics data, the user's current attention level, the type of message or user device activity, the urgency of the message or user device activity, etc. Additionally, or alternatively, the attention provoking instructions criteria repository 223 stores another set of attention level criteria that defines a threshold attention level that the user should maintain, and a threshold amount of time that the attention level should be maintained.

At step 4.4, while the attention provoking actions are performed (e.g., by executing the attention provoking instructions) the user activity biometrics monitoring module 221 continues to monitor the user's activity and biometrics to determine the user's attention level during execution of the attention provoking instructions. In embodiments, the attention provoking instruction execution module 224 detects, based on the user's attention level derived from the user's activity and biometrics, that the user has devoted sufficient time and attention to the e-mail message (e.g., based on the rules from step 4.2 and/or the criteria stored by the attention provoking instructions criteria repository 223). At step 4.5, the attention provoking instruction execution module 224 determines that the user's response focus has been re-aligned to the e-mail message when the user has devoted sufficient time and attention to the e-mail message and may discontinue the attention provoking actions (e.g., by discontinuing execution of the attention provoking instructions). In this way, the attention provoking action is maintained until the user has devoted sufficient time and attention to the e-mail message. While an e-mail message is shown in the example of FIG. 4, aspects of the present invention are not so limited and apply to other types of notifications/messages (e.g., text messages, application notifications, emergency alerts, etc.).

In embodiments, the attention provoking effectiveness determination module 225 determines the effectiveness of the attention provoking actions based on the user's attention level during the attention provoking actions. The attention provoking effectiveness determination module 225 updates the criteria stored by the attention provoking instructions criteria repository 223 based on the effectiveness of the attention provoking actions. For example, if the attention provoking actions were not effective, different attention provoking actions are taken to re-focus the user's attention. The user activity biometrics monitoring module 221 continues to monitor the user's activity and biometrics to determine the user's attention level, and once the attention provoking actions are determined to be effective, the attention provoking effectiveness determination module 225 updates the attention provoking instructions criteria repository 223 such that effective provoking actions are taken in the future when attention provoking actions are triggered. In this way, the attention provoking system 220 “self-learns” and adapts to different ways to effectively re-focus the user's attention, as different users may respond differently to different attention provoking actions under different environments and conditions.

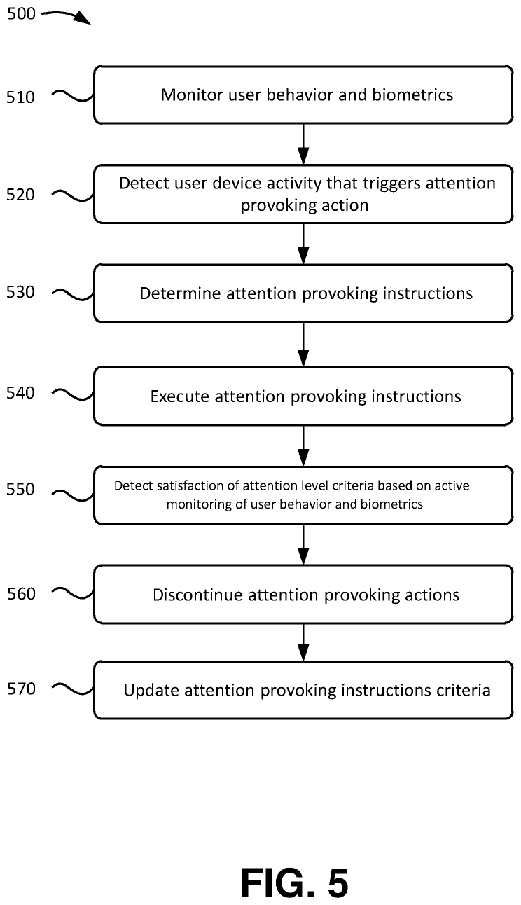

FIG. 5 shows an example flowchart of a process for initiating an attention provoking action and maintaining the attention provoking action until sufficient time and attention has been given to a message. In embodiments, the steps of FIG. 5 are implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

As shown in FIG. 5, process 500 includes monitoring user behavior and biometrics (step 510). For example, as described above with respect to the user activity biometrics monitoring module 221, the attention provoking system 220 monitors user behavior and biometrics by continuously receiving and/or storing sensor data for a user, such as the user's biometrics data and/or other user activity (e.g., the user's speaking activity, movement activity, eye behavior, etc.). As described herein, the attention provoking system 220 monitors the user behavior throughout process 500. Also, the attention provoking system 220 identifies the user based on user identification information (e.g., facial recognition, user login information, through the user of wearable computing devices, IoT devices, etc.). As described herein, the user's identification information is used to identify a custom set of attention provoking criteria for the user.

Process 500 also includes detecting user device activity that triggers attention provoking action (step 520). For example, as described above with respect to the user device activity and messaging monitoring module 222, the attention provoking system 220 detects user device 210 activity that triggers attention provoking. In embodiments, the attention provoking system 220 detects that a message on the user device 210 has been received and that the message requires an attention provoking action (e.g., to cause the user to devote sufficient time and attention to the message). In embodiments, the attention provoking system 220 determines that the message triggers an attention provoking action based on metadata, header data, and/or other information within the message. As an illustrative example, the message includes a flag indicating urgency. Additionally, or alternatively, the attention provoking system 220 determines that the message triggers an attention provoking action based on the content of the message. For example, in embodiments, the attention provoking system 220 applies, to the message, natural language classification (NLC), natural language processing (NLP), sentiment/tone analysis, and/or any other suitable technique to determine whether the content of the message indicates urgency, and the level of urgency. In embodiments, the attention provoking system 220 uses criteria to map the content, sentiment, tone, words, etc., of the message with criteria indicating the level of urgency of the message.

In embodiments, (e.g., when the message is sent by a sending party, such as an e-mail, message, text message, etc.), the attention provoking system 220 detects whether attention provoking actions should be triggered based on a sender's desire to trigger the attention provoking actions (e.g., based on an urgency level indicated by the sender). Additionally, or alternatively, the attention provoking system 220 detects whether attention provoking actions should be triggered based on the recipient's preferences (e.g., the preferences of the user of the user device 210 to have the attention provoking actions triggered). In embodiments, the attention provoking system 220 detects a confidence level that the sender and/or recipient wish to have the attention provoking actions triggered and the attention provoking system 220 detects that attention provoking actions should be triggered when the confidence level satisfies a threshold.

Process 500 further includes determining attention provoking instructions (step 530). For example, as described above with respect to the attention provoking instruction execution module 224, the attention provoking system 220 determines a particular set of attention provoking instructions to execute based on criteria stored by the attention provoking instructions criteria repository 223. In embodiments, attention provoking instructions criteria repository 223 stores a custom set of criteria associated with the user (e.g., the user as identified at step 510). As an example, the attention provoking instructions criteria repository 223 stores criteria that a particular set of attention provoking actions should be taken for an e-mail message with a particular urgency or priority level, when the user's attention level is low (e.g., as determined by the user's behavior and/or biometrics), and when the user's surrounding environment and activity safely allows for the attention provoking actions to take place (e.g., when the user is not driving, or otherwise occupied with other actions whereby an attention provoking action is deemed to be unsafe). In embodiments, the criteria indicate a time to execute the attention provoking instructions (e.g., immediately, or after a delay if the user's current surrounding and environment does not safely allow for the provoking actions to take place). In embodiments, the criteria indicate the duration and severity of the attention provoking instructions. In embodiments, the duration and severity of the attention provoking instructions is based on the user's attention level, urgency or priority level of the message, confidence level that the sender and/or recipient wishes to trigger the attention provoking instructions (e.g., as determined at step 520), and/or based on any other combination of factors.

In embodiments, the attention provoking system 220 determines that no attention provoking is currently needed when the user's attention level satisfies attention level criteria. However, the attention provoking system 220 continues to monitor the user's activity and biometrics (e.g., in accordance with process step 510). The attention provoking system 220 detects if the user's attention does not satisfy a threshold, at which point the attention provoking system 220 determines appropriate attention provoking instructions as described above.

Process 500 also includes executing the attention provoking instruction (step 540). For example, as described above with respect to the attention provoking instruction execution module 224. the attention provoking system 220 executes the attention provoking instruction in order to perform an attention provoking action on the user device 210. As illustrative non-limiting examples, attention provoking actions include one or more of: flickering a display of the user device 210, blinking a certain section of the user device 210 having an important notification/message, outputting an audible alert, adjusting a frame rate of the display, highlighting portions of the display, and/or other actions (e.g., motion sickness type actions) that provoke and/or re-focus or restore the user's attention.

Process 500 further includes detecting satisfaction of attention level criteria based on active monitoring of user behavior and biometrics (step 550). For example, as described above with respect to the attention provoking instruction execution module 224, the attention provoking system 220 detects satisfaction of attention level criteria based on active monitoring of user behavior and biometrics (e.g., the active monitoring occurring at step 510 and throughout process 500). In embodiments, the attention provoking system 220 identifies the attention level criteria to be satisfied from the attention provoking instructions criteria repository 223. Additionally, or alternatively, in an example embodiment, the message itself includes attention level criteria (e.g., in the form of an instruction, header details, urgency level, etc. embedded within the message). An example of attention level criteria to be satisfied is that the user must have a threshold attention level for a threshold period of time to review an e-mail message having a particular urgency level. The attention provoking system 220 continues to monitor the user's activity and biometrics to determine the user's attention level during execution of the attention provoking instructions (e.g., in accordance with step 510). The attention provoking system 220 detects, based on the user's attention level derived from the user's activity and biometrics, that the user has devoted sufficient time and attention to the message based on the attention level criteria to be satisfied.

Process 500 also includes discontinuing attention provoking actions (step 560). For example, as described above with respect to the attention provoking instruction execution module 224, the attention provoking system 220 discontinues the attention provoking actions based on detecting the satisfaction of attention provoking criteria (e.g., from step 550).

Process 500 further includes updating the attention provoking instructions criteria (step 570). For example, as described above with respect to the attention provoking effectiveness determination module 225, the attention provoking system 220 determines the effectiveness of the attention provoking actions based on the user's attention level during the attention provoking actions. The attention provoking system 220 updates the criteria (e.g., the attention provoking criteria and/or the attention level criteria) stored by the attention provoking instructions criteria repository 223 based on the effectiveness of the attention provoking actions.

As described herein, aspects of the present invention detects a user's habit using different sensors that indicate how different messages are treated (e.g. 78% of all “Important” messages are handled within 20 minutes and have at least 120 seconds devoted to them). Aspects of the present invention begin provoking actions for a received message based on a threshold and sensor trigger detection. If the message is not being adequately read (e.g. paragraphs are being skipped in the message), aspects of the present invention slightly change the frame rate on the monitor or a slight “flicker” on the monitor for the recipient to force the user to “re-focus” and get restore attention. Aspects of the present invention monitor the user's behavior while the provoking actions are exposed to the user. Aspects of the present invention determine a level to which the provoking actions are in response to exposure and adjusts the provoking actions to the individual user's response. Aspects of the present invention end the provoking actions when the user's actions and attention level meet the user habit completion.

In embodiments, aspects of the present invention provide a processor-implemented method for increasing user awareness to a message. In embodiments, the method includes: determining user behavior while reviewing important messages through wearables, internet of things devices, and facial recognition technology; in response to user activity while reading a specific important message deviating from the determined user behavior, initiating a change in a device display, wherein the change is annoying to the user or triggers motion sickness symptoms; and in response to the user activity returning to a conformity with the determined user behavior, removing the change.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
monitoring, by the computing device, user behavior and user biometrics of a user,
detecting, by the computing device, user device activity of a user device that triggers an attention provoking action;
executing, by the computing device, attention provoking instructions based on the detecting the user device activity that triggers the attention provoking action;
detecting, by the computing device, that attention level criteria has been satisfied based on the monitoring the user behavior and the user biometrics; and
discontinuing, by the computing device, the executing the attention provoking instructions based on the detecting that the attention level criteria has been satisfied.

2. The computer-implemented method of claim 1, wherein the user behavior and the user biometrics indicate the user's attention level.

3. The computer-implemented method of claim 1, further comprising determining the attention provoking instructions based on attention provoking criteria.

4. The computer-implemented method of claim 3, further comprising determining an effectiveness of the attention provoking instructions and updating the attention provoking criteria or the attention level criteria based on the effectiveness of the attention provoking instructions.

5. The computer-implemented method of claim 3, wherein the attention provoking criteria includes at least one selected from the group consisting of:
the user's current behavior;
the user's current biometrics data;
the user's current attention level;
an urgency level of the user device activity that triggers the attention provoking action; and
a type of the user device activity that triggers the attention provoking action.

6. The computer-implemented method of claim 1, wherein the attention level criteria define a threshold level of user attention that has been maintained for a threshold period of time.

7. The computer-implemented method of claim 1, wherein the attention provoking instructions include at least one selected from the group consisting of:
flickering a display of the user device;
blinking a particular section of the user device;
outputting an audible alert;
adjusting a frame rate of the display of the user device; and
highlighting a portion of the display of the user device.

8. The computer-implemented method of claim 1, further comprising maintaining execution of the attention provoking instructions until the detecting the attention level criteria has been satisfied.

9. The computer-implemented method of claim 1, wherein the device activity comprises a message or notification.

10. The computer-implemented method of claim 1, wherein a service provider at least one of creates, maintains, deploys and supports the computing device.

11. The computer-implemented method of claim 1, wherein the monitoring the user behavior and the biometrics; the detecting the user device activity that triggers the attention provoking actions, the executing the attention provoking instructions; the detecting that attention level criteria have been satisfied; and the discontinuing the executing the attention provoking instructions are provided by a service provider on a subscription, advertising, and/or fee basis.

12. The computer-implemented method of claim 1, wherein the computing device includes software provided as a service in a cloud environment.

13. The computer-implemented method of claim 1, further comprising deploying a system for maintaining a user's attention based on urgent user device activity, comprising providing a computer infrastructure operable to perform the monitoring the user behavior and the biometrics; the detecting the user device activity that triggers the attention provoking actions, the executing the attention provoking instructions; the detecting that attention level criteria has been satisfied; and the discontinuing the executing the attention provoking instructions.

14. A computer program product comprising a computer readable storage medium having program instructions embodied therewith, the program instructions executable by a computing device to cause the user device to:
monitor user behavior and user biometrics indicating a user's attention level;
receive a message that triggers an attention provoking action on the user device;
execute attention provoking instructions based on the receiving the message that triggers the attention provoking action; and
maintain execution of the attention provoking instructions until the computing device detects, based on the monitoring the user behavior and the user biometrics, that the user's attention level has satisfied a threshold for a threshold period of time.

15. The computer program product of claim 14, wherein the program instructions further cause the computing device to detect that the message triggers the attention provoking action based on an urgency level of the message satisfying a threshold, wherein the executing the attention provoking instructions is based on the detecting that the message triggers the attention provoking action based on the urgency level.

16. The computer program product of claim 15, wherein the urgency level is determined based on at least one selected from the group consisting of:
an urgency flag embedded in the message;
a rule embedded in the message;
applying natural language classification to the message;
applying natural language processing to the message; and
applying sentiment or tone analysis to the message.

17. The computer program product of claim 14, wherein the message is at last one selected from the group consisting of:
an e-mail message;
a text message;
an instant message;
an application notification or alert;
an emergency alert; and
a telephone call.

18. The computer program product of claim 14, wherein the attention provoking instructions include at least one selected from the group consisting of:
flickering a display of the user device;
blinking a particular section of the user device;
outputting an audible alert;
adjusting a frame rate of the display of the user device; and
highlighting a portion of the display of the user device

19. A system comprising:
a processor, a computer readable memory and a computer readable storage medium associated with a user device;
program instructions to monitor user behavior and user biometrics,
program instructions to provide a message to a user of the user device;
program instructions to determine that an urgency level of the message exceeds a threshold;
program instructions to execute attention provoking instructions based on the detecting that the urgency level exceeds the threshold;
program instructions to detect that attention provoking criteria has been satisfied based on the monitoring the user behavior and the user biometrics; and
program instructions to discontinue the executing the attention provoking instructions based on the detecting that the attention provoking criteria has been satisfied,
wherein the program instructions are stored on the computer readable storage medium for execution by the processor via the computer readable memory.

20. The system of claim 19, wherein the attention provoking instructions include at least one selected from the group consisting of:
flickering a display of the user device;
blinking a particular section of the user device;
outputting an audible alert;
adjusting a frame rate of the display of the user device; and
highlighting a portion of the display of the user device.
